(19) United States
(12) Patent Application Publication
(10) Pub. No.: US 2022/0164080 A1
(43) Pub. Date: May 26, 2022

(54) PRESSURE SENSING DEVICE, PRESSURE SENSING METHOD, AND ELECTRONIC TERMINAL

(71) Applicant: SHENZHEN NEW DEGREE TECHNOLOGY CO., LTD., Shenzhen, Guangdong (CN)

(72) Inventor: Hao LI, Shenzhen, Guangdong (CN)

(21) Appl. No.: 17/440,986

(22) PCT Filed: Mar. 20, 2019
(86) PCT No.: PCT/CN2019/078852

§ 371 Date: Sep. 20, 2021

(51) Int. Cl. G06F 3/041; G06F 3/044

(52) U.S. Cl. CPC G06F 3/04146; G06F 3/0447; G06F 2203/04111; G06F 2203/04105; G06F 3/0445

(57) ABSTRACT

A pressure sensing device, including a rigid structure, a touch sensor, and a pressure sensor. The pressure sensing device is a modular integrated solution for touch position recognition and pressure detection, it is not necessary for a user to separately purchase and install different components. The touch sensor and the pressure sensor are both arranged adjacent to the rigid structure, and the structure is simple and compact. The touch sensor is electrically connected to the touch processing circuit to realize the position recognition of the measured object. The measured object deforms when it is pressed, the rigid structure follows the measured object to deform, and the pressure sensor is electrically connected to the pressure processing circuit to obtain the measured object at the touch position, thereby achieving the function of pressure touch.

### TECHNICAL FIELD

The present application relates to the field of pressure sensing technology, and more particularly to a pressure sensing device, a pressure sensing method, and an electronic terminal.

### BACKGROUND

At present, there are many different types of pressure sensing technology on the market, such as pressure capacitance technology, pressure inductance technology, and MEMS (Micro Electro Mechanical System) pressure sensor technology, etc. These technologies have disadvantages of high structural requirement, cumbersome installation, low sensitivity, low anti-drop coefficient, and high cost.

### Technical Problem

An objective of the present application is to provide a pressure sensing device, a pressure sensing method, and an electronic terminal, which aim to solve the technical problems of high structural requirements and cumbersome installation in the existing pressure sensing technology.

### Technical Solution

In accordance with an embodiment of the present application, it is provided a pressure sensing device, which includes a rigid structure configured for pressing against a measured object and following a deformation of the measured object, a touch sensor arranged adjacent to the rigid structure, and a pressure sensor arranged adjacent to the rigid structure. The touch sensor is electrically connected with a touch processing circuit to detect whether the measured object is touched by an external object and to detect a position being touched on the measured object. The pressure sensor is electrically connected with a pressure processing circuit to detect a deformation of the rigid structure and to obtain a pressure of the measured object at the touched position.

In accordance with an embodiment of the present application, it is provided a pressure sensing method, which uses the above-mentioned pressure sensing device to implement the following steps:

pressing the rigid structure against a measured object;

detecting, by the touch sensor, whether the measured object is touched by an external object; setting the touch processing circuit in a sleep mode when no touch event is detected; setting the touch processing circuit in a normal mode when a touch event is detected, and detecting a position being touched on the measured object; and

detecting, by the pressure sensor, a deformation of the measured object and obtaining a pressure of the measured object at the touched position.

In accordance with an embodiment of the present application, it is provided an electronic terminal, which includes a measured object and the aforementioned pressure sensing device, where the rigid structure is pressed against the measured object.

### Advantageous Effects

The pressure sensing device disclosed herein is a modular integrated solution for touch position recognition and pressure detection, it is not necessary for users to separately purchase and install different components. The touch sensor and the pressure sensor are both arranged adjacent to the rigid structure, thus the structure of the pressure sensing device is simple and compact. It can be used by simply pressing the rigid structure against the measured object, thus the operation is convenient. The position recognition of the measured object can be realized as the touch sensor is electrically connected to the touch processing circuit. The measured object deforms when it is pressed, the rigid structure follows the deformation of the measured object, and the pressure sensor is electrically connected to the pressure processing circuit, the pressure of the measured object at the touched position can be detected, thereby achieving the function of pressure touch. This pressure sensing device can well meet the performance indicators such as no false touch, low power consumption, high sensitivity, fast response, high anti-drop coefficient, and high reliability, and provides good operating experience.

The pressure sensing method and the electronic terminal, using the above pressure sensing device, can also realize the position recognition of a measured object, and obtain the pressure of the measured object at the touched position, and provide good operating experience.

### BRIEF DESCRIPTION OF THE DRAWINGS

In order to explain the technical solutions in the embodiments of the present application more clearly, the drawings that need to be used in the description of the embodiments or the existing technologies will be briefly described herein below. Obviously, the drawings in the following description are merely some embodiments of the present application, and for those of ordinary skill in the art can obtain other drawings on the basis of these drawings without creative labor.

FIG. 1 is a schematic structural diagram of a pressure sensing device according to an embodiment of the present application;

FIG. 2 is a schematic structural diagram of a touch sensor using capacitance sensing elements according to an embodiment of the present application;

FIG. 3 is a schematic diagram of a pressure sensor using strain sensing resistors to form a bridge circuit according to an embodiment of the present application;

FIG. 4 is a schematic structural diagram of a pressure sensing device according to another embodiment of the present application; and

FIG. 5 is a schematic structural diagram of a pressure sensing device according to another embodiment of the present application.

### DETAILED DESCRIPTION OF THE EMBODIMENTS

In order to make the objectives, technical solutions and advantages of the present application clearer and more understandable, the present application is further described in detail below with reference to accompanying figures and embodiments hereinafter. It should be understood that the specific embodiments described herein are merely intended to illustrate but not to limit the present application.

In the description of the embodiments of the present application, it should be understood that the terms “length”, “width”, “upper”, “lower”, “front”, “rear”, “left”, “right”, “vertical”, “horizontal”, “top”, “bottom”, “inner”, “outer” and other directions or positional relations are based on the positions or positional relations shown in the drawings, and are only for the convenience of describing the embodiments of the present application and simplifying the description, rather than indicating or implying that the device or element referred to must have a specific orientation, be configured and operated in a specific orientation, and therefore cannot be understood as a limitation to the embodiments of the present application.

In addition, the terms “first” and “second” are merely used for the purpose of description, and cannot be understood as indicating or implying relative importance or implicitly indicating the number of indicated technical features. Thus, the features defined with “first” and “second” may explicitly or implicitly include one or more of these features. In the description of the present application, “a plurality of” means two or more, unless otherwise specifically defined.

In the embodiments of the present application, unless otherwise clearly specified and defined, the terms “installed/mounted”, “in contact with”, “connected/coupled”, “fixed” and other terms should be understood in a broad sense. For example, it may be fixed connected or detachably connected or may be integrated; it can be a mechanical connection or an electrical connection; it may be directly connected or indirectly connected through an intermediate medium, and it may be an internal communication of two components or an interaction relationship between the two components. For those of ordinary skill in the art, the specific meanings of the above-mentioned terms in the embodiments of the present application can be understood according to specific conditions.

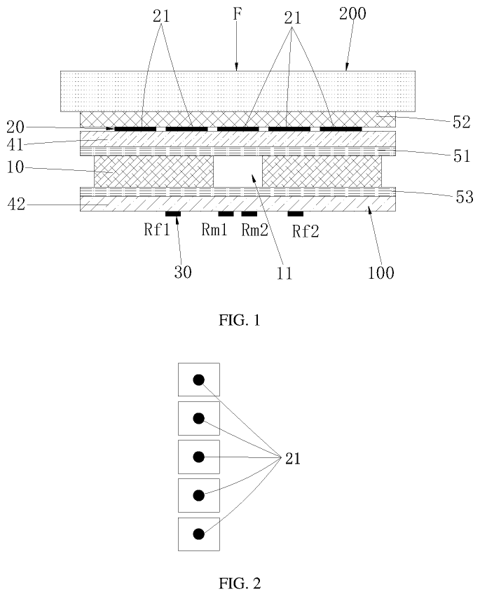

Please refer to FIGS. 1, 4, and 5, it is provided a pressure sensing device 100 according to an embodiment of the present application, which may include: a rigid structure 10 configured for pressing against a measured object 200 and following a deformation of the measured object 200, a touch sensor 20 arranged adjacent to the rigid structure 10, and a pressure sensor 30 arranged adjacent to the rigid structure 10. The touch sensor may be electrically connected with a touch processing circuit to detect whether the measured object 200 is touched by an external object and detect a position being touched on the measured object 200. The pressure sensor 30 may be electrically connected with a pressure processing circuit to detect the deformation of the rigid structure 10 and obtain a pressure of the measured object 200 at the touched position. Here, the pressing against may be a situation where two structural members directly press against each other, or a situation where the two structural members press against each other with other structural members arranged therebetween.

The pressure sensing device 100 may be a modular integrated solution for touch position recognition and pressure detection, and it is not necessary for users to separately purchase and install different components. The touch sensor 20 and the pressure sensor 30 may both be arranged adjacent to the rigid structure 10, and the structure is simple and compact. It can be used by simply pressing the rigid structure 10 against the measured object 200, thus the operation is convenient. The touch sensor 20 is electrically connected with the touch processing circuit to realize the position recognition of the measured object 200. The measured object 200 deforms when it is pressed, the rigid structure 10 deforms following the deformation of the measured object 200, and the pressure sensor 30 is electrically connected with the pressure processing circuit to obtain the pressure of the measured object 200 at the touched position, thereby realizing the function of pressure touch. The pressure sensing device 100 can well meet the performance indicators such as no false touch, low power consumption, high sensitivity, fast response, high anti-drop coefficient, high reliability, etc., and provides good operating experience.

It should be noted that both the touch processing circuit and the pressure processing circuit belong to known technologies. The touch processing circuit is configured to analyze and process the electrical signal of the touch sensor 20 to obtain touch position information, and convert a touch analog signal into a touch digital signal. The pressure processing circuit is configured to analyze and process the electrical signal of the pressure sensor 30 to obtain the pressure at the touched position, and convert a pressure analog signal into a pressure digital signal. The digital signal may be received and processed by a controller, such that a precise pressure of the touch can be obtained while the touched position can be recognized.

In another embodiment of the present application, the measured object 200 takes the XY plane as a position recognition plane, and the touch pressure can be detected in the Z direction, where the Z direction is perpendicular to the XY plane. The pressure sensing device 100 can realize the touch position recognition and the pressure detection.

In another embodiment of the present application, the specific number of the pressure sensor 30 and the touch sensor 20 is not limited. In practical applications, the pressure sensor 30 and touch sensor 20 may be one-channel or multi-channel. The pressure sensing device 100 shown in FIG. 1 is configured with a 1-channel pressure sensor 30 and a 5-channel touch sensor 20.

In another embodiment of the present application, the rigid structure 10 has a certain rigidity, may be sheet-shaped, and has a compact structure, which is convenient for the rigid structure 10 to follow the measured object 200 to deform when the measured object 200 is pressed, and the deformation of the rigid structure 10 is detected by the pressure sensor 30. Specifically, the rigid structure 10 may be steel sheet, aluminum sheet, glass, FR4 or other composite rigid materials, which can be selected according to actual needs.

Referring to FIGS. 1, 2, and 4, in another embodiment of the present application, a first substrate 41 is provided in contact with a surface of the rigid structure 10 facing the measured object 200. The touch sensor 20 includes a capacitance sensing element 21 arranged on a surface of the first substrate 41. The touch processing circuit is configured to detect a capacitance change of the capacitance sensing element 21 to detect whether the measured object 200 is touched by an external object and detect a position being touched on the measured object 200. When an external object touches the measured object 200, the capacitance of the corresponding capacitance sensing element 21 is changed. Based on the capacitance change detected through the touch processing circuit, it can be detected whether the measured object 200 is touched by the external object and the position being touched on the measured object 200 can also be detected. Specifically, the capacitance sensing element 21 may be printed circuit board (PCB) copper foil, metal sheet, flat-top cylindrical spring, conductive cotton, conductive ink, conductive rubber, conductive glass indium tin oxide (ITO) layer, and the like.

The touch sensor 20 may include a capacitance sensing element 21. When a human hand is far away from the measured object 200 and the surrounding environment does not change, the touch processing circuit does not detect a change in the capacitance of the capacitance sensing element 21, and the circuit is in a sleep state with ultra-low power consumption. When the measured object 200 is touched by a human hand, the touch processing circuit detects the capacitance change of the corresponding capacitance sensing element 21, and determine according to the detected signal that the corresponding capacitance sensing element 21 is touched. When the signal reaches a certain threshold, the touch processing circuit is switched to a normal mode of high frequency scanning and output a touch digital signal. At this time, the pressure sensor 30 of the pressure sensing device 100 is not affected by force, and the output pressure signal is adjacent to zero. When the human hand touches the measured object 200, and applies a pressure, the touch processing circuit can determine the specific position touched by the human hand by detecting the capacitance information of the touch sensor 20 of each channel, and the pressure processing circuit detects the magnitude of the output voltage signals of the pressure sensor 30 of the different channels, thereby converting the magnitude of the applied pressure.

In another embodiment of the present application, the capacitance sensing elements 21 may be distributed on the first substrate 41 in an array. In this solution, the assembling is easy, and the capacitance sensing elements 21 are arranged in multiple positions to realize the recognition of multiple positions. For example, the capacitance sensing elements 21 shown in FIG. 2 are distributed in a straight line to realize one-dimensional position recognition.

Referring to FIGS. 1 and 4, in another embodiment of the present application, the rigid structure 10 and the first substrate 41 are connected through a first adhesive layer 51. This structure facilitates the connection between the rigid structure 10 and the first substrate 41, and allows the first substrate 41 and the rigid structure 10 to follow the measured object 200 to deform when the measured object 200 is deformed. The first adhesive layer 51 may include epoxy glue film, 502 glue, thermosetting glue or other materials, which can be selected as required.

In another embodiment of the present application, when the touch sensor 20 uses the capacitance sensing elements 21, the capacitance sensing elements 21 and the measured object 200 are connected through a second adhesive layer 52. It is convenient to attach the pressure sensing device 100 to the measured object 200 through the second adhesive layer 52 to achieve instant application. The second adhesive layer 52 may include VHB acrylic styrofoam glue, double-sided glue, UV glue, AB glue or foam glue.

Referring to FIG. 1, in another embodiment of the present application, a second substrate 42 is provided in contact with a surface of the rigid structure 10 facing away from the measured object 200, and the pressure sensor 30 is disposed on the second substrate 42. The structure is compact, and easy to form, which can facilitate the installation of the pressure sensor 30, and thereby realizing pressure sensing.

Particularly, the first substrate 41 and the second substrate 42 may be PET film (high temperature resistant polyester film), PI film (polyimide film), or other applicable flexible materials, which can be selected on demand.

In another embodiment of the present application, the pressure sensor 30 may be strain sensing resistors, which is made of at least one material selected from a group consisting of polycrystalline semiconductor materials, amorphous semiconductor materials, polysilicon, graphene, copper-nickel alloys, carbon nanotubes, thin metal wires, and conductor insulators. All of the above strain sensing resistors can realize pressure sensing, and can be selected on demand.

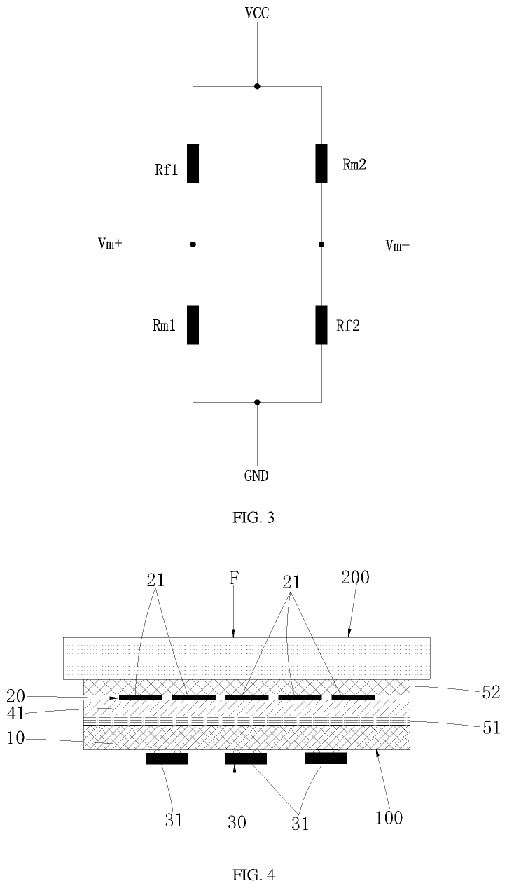

Referring to FIGS. 1 and 3, in another embodiment of the present application, the pressure sensor 30 is a strain sensing resistor, and every four strain sensing resistors (Rm1, Rm2, Rf1, and Rf2) are electrically connected to form a bridge circuit. When the measured object 200 is deformed by pressing, the rigid structure 10 and the second substrate 42 follow the deformation, and the deformation of the measured object 200 can be accurately measured by the bridge circuit thereby achieving pressure sensing.

In another embodiment of the present application, the rigid structure 10 has a strain amplifying zone 11, and the four strain sensing resistors in the bridge circuit form two sets of bridge arms opposite to each other. Among them, two strain sensing resistors (Rm1, Rm2) of one set of the bridge arms are arranged corresponding to the strain amplification zone 11, and two strain sensing resistors (Rf1, Rf2) of the other set of the opposite bridge arms are arranged to offset the strain amplification zone 11. This solution can effectively realize pressure sensing. When a force F is applied to the measured object 200, after the pressure is transmitted to the rigid structure 10, the deformation of the second substrate 42 in the area corresponding to the strain amplification zone 11 is relatively large, and the deformation in the area outside the strain amplification zone 11 is relatively small.

The output electrical signal may be:

ΔV=(Vm+)−(Vm−)=[Rm1/(Rf1−PRm1)−Rf2/(Rf2+Rm2)]VCC

Deriving ΔV to Rm1, Rm2, Rf1, and Rf2 respectively, it can be seen that ΔV increases with the increase of Rm1 or Rm2, and ΔV decreases with the increase of Rf1 or Rf2. When a force F is applied to the measured object 200, both Rm1 and Rm2 change greatly in the positive direction, while the change of Rf1 or Rf2 in the positive direction is relatively small. Because the change of Rf1 or Rf2 is relatively tiny compared to Rm1 and Rm2 It is assumed that Rf1 and Rf2 remain unchanged, so that when a force is applied to the measured object 200, ΔV increases with the increase of the applied force F, and the strain sensing resistance is a linear pressure output, that is, the magnitude of the applied force can be calculated with the magnitude of ΔV. Particularly, the strain amplification zone 11 may be a through hole or other structures capable of amplifying strain provided in the rigid structure 10.

In another embodiment of the present application, the rigid structure 10 and the second substrate 42 may be connected through a third adhesive layer 53. This structure facilitates the connection between the rigid structure 10 and the second substrate 42 and allows the second substrate 42 to follow the deformation when the object 200 is deformed by pressing and the rigid structure 10 follows the deformation. The third adhesive layer 53 may include epoxy glue film, 502 glue, thermosetting glue or other materials, which can be selected as required.

Referring to FIG. 4, in another embodiment of the present application, the pressure sensor 30 is disposed on the surface of the rigid structure 10, and the pressure sensor 30 is at least one of a micro-electromechanical (MEMS) pressure sensor 31, a capacitance pressure sensor, and an inductive pressure sensor. All of the above pressure sensors can realize pressure sensing and can be selected according to actual needs. The micro-electromechanical pressure sensor 31 has a size on the order of micrometers, has a compact structure, and can realize pressure sensing. The capacitance pressure sensor is a pressure sensor that uses capacitance sensitive elements to convert the measured pressure into an electrical output signal that has a certain relationship with it. The inductive pressure sensor is a pressure sensor that utilizes a change in the inductance of an inductance coil to measure pressure.

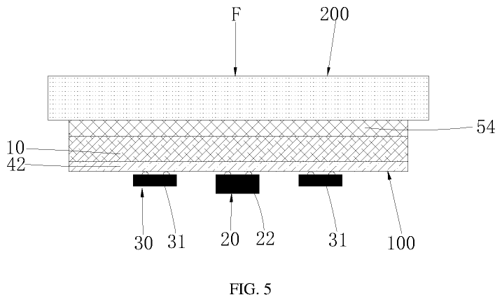

Referring to FIG. 5, in another embodiment of the present application, the touch sensor 20 includes an ultrasonic sensor 22 disposed on the second substrate 42. The ultrasonic sensor 22 is configured to convert an ultrasonic signal into an electrical signal to realize the touch position recognition of the measured object 200. Alternatively, the touch sensor 20 includes an infrared sensor (not shown) disposed on the second substrate 42. The Infrared sensor may include a photon detector based on the photoelectric effect detection mechanism or a thermal detector based on the thermal effect detection mechanism. The above schemes can all realize the touch position recognition of the measured object 200, which can be selected as required.

In another embodiment of the present application, when the touch sensor 20 is an ultrasonic sensor 22 or an infrared sensor, the pressure sensor 30 is disposed on the surface of the second substrate 42, and the pressure sensor 30 may be at least one of a micro-electromechanical (MEMS) pressure sensor 31, a capacitance pressure sensor and an inductive pressure sensor. The above schemes can all realize pressure sensing and can be selected according to actual needs.

In another embodiment of the present application, when the touch sensor 20 is an ultrasonic sensor 22 or an infrared sensor, the rigid structure 10 and the measured object 200 are connected through a fourth adhesive layer 54. It is convenient to attach the pressure sensing device 100 to the measured object 200 through the fourth adhesive 54 to achieve instant application. The fourth adhesive layer 54 may include VHB acrylic styrofoam glue, double-sided glue, UV glue, AB glue or foam glue.

Referring to FIGS. 1, 4, and 5, in another embodiment of the present application, it is provided a pressure sensing method, which uses the pressure sensing device 100 of any of the above embodiments, to implement the following steps:

pressing the rigid structure 10 against a measured object 200;

detecting, by the touch sensor 20, whether the measured object 200 is touched by an external object; where the touch processing circuit, by judging whether there is a touch event, is set to be in a sleep mode or a normal mode, where the power consumption of the touch processing circuit is low in the sleep mode; and the touch sensor works in high frequency scanning in the normal mode; when no touch event is detected, the touch processing circuit is in the sleep mode; when a touch event is detected, the touch processing circuit is in the normal mode, and detecting a position being touched on the measured object 200;

detecting, by the pressure sensor 30, a deformation of the measured object 200 and obtaining a pressure of the measured object 200 at the touched position.

Referring to FIGS. 1, 4, and 5, in another embodiment of the present application, it is provided an electronic terminal, including a measured object 200 and the pressure sensing device 100 of any one of the above embodiments. Where the rigid structure 10 is pressed against the measured object 200.

As the electronic terminal uses all the technical solutions of all the above-mentioned pressure sensing device embodiments, it also has all the beneficial effects brought by the technical solutions of the above-mentioned embodiments, which will not be repeated here.

In another embodiment of the present application, the measured object 200 may be a panel or a frame. The position recognition and pressure sensing of the panel or frame can be achieved. The panel or frame may be made of glass, plastic, ceramic and/or other non-metallic materials. The panel may be a touch screen, a display or other electronic terminal with a rigid structure 10. The frame may be a frame of various electronic terminals. By coupling the touch sensor 20 and the pressure sensor 30 to the panel or the frame, it is possible to accurately identify the touched position while accurately identifying the magnitude of the touch pressure, which expands the application of electronic terminals in product applications, human-computer interaction and consumer experience space. By touching the touch screen, display or electronic terminal, the user can directly obtain the precise level and magnitude of the pressure. After calibration, the precise pressure of pressing can be obtained.

In another embodiment of the present application, a controller is further included for outputting a predetermined instruction to control the corresponding actuator according to the touched position obtained by the touch processing circuit and the pressure obtained by the pressure processing circuit. In the controller, the relationship between the pressure signals at various levels and the realized functions is defined, and different touch functions under different pressures can be realized. The touch processing circuit may provide touch digital signals, the pressure processing circuit may provide touch digital signals, and the controller performs storage and signal processing to obtain touch position information and pressure information. In this way, user action events such as touch, single light press, single heavy press, multiple presses, long press, and sliding can be obtained. By setting a response mechanism, the action events can be output in a specific form. The actuator may be a drive motor, LED, buzzer or other actuators.

Particularly, the controller can be implemented as a general-purpose processor, a content addressable memory, a digital signal processor, a digital-to-analog switch, a programmable logic device, a discrete hardware composition or other combinations. Meanwhile, it is also embedded with pressure algorithm and software information related to touch screen/pressure sensing system.

The forgoing are only preferred embodiments of the present application, and should not be regarded as the limitation to the present application. Any modification, equivalent replacement, improvement, and the like, which are made within the spirit and the principle of the present application, should all be included in the protection scope of the present application.

What is claimed is:

1. A pressure sensing device, comprising:
a rigid structure, configured for pressing against a measured object and following a deformation of the measured object;
a touch sensor, arranged adjacent to the rigid structure; and
a pressure sensor, arranged adjacent to the rigid structure,
wherein the touch sensor is electrically connected with a touch processing circuit to detect whether the measured object is touched by an external object and to detect a position being touched on the measured object, and wherein the pressure sensor is electrically connected with a pressure processing circuit to detect a deformation of the rigid structure and obtain a pressure of the measured object at the touched position.

2. The pressure sensing device according to claim 1, wherein a first substrate is provided in contact with a surface of the rigid structure facing the measured object, and the touch sensor comprises a capacitance sensing element disposed on a surface of the first substrate, wherein the touch processing circuit is configured to detect a capacitance change of the capacitance sensing element to detect whether the measured object is touched by the external object and to detect the position being touched on the measured object.

3. The pressure sensing device according to claim 2, wherein the capacitance sensing element is distributed on the first substrate in an array.

4. The pressure sensing device according to claim 2, wherein the rigid structure and the first substrate are connected through a first adhesive layer; and/or the capacitance sensing element and the measured object are connected through a second adhesive layer.

5. The pressure sensing device according to claim 1, wherein a second substrate is provided in contact with a surface of the rigid structure facing away from the measured object, and the pressure sensor is disposed on the second substrate.

6. The pressure sensing device according to claim 5, wherein the pressure sensor comprises strain sensing resistors, and the strain sensing resistors are made of at least one material selected from the group consisting of polycrystalline semiconductor materials, amorphous semiconductor materials, polysilicon, graphene, copper-nickel alloy, carbon nanotubes, thin metal wires, and conductor-insulator composite materials.

7. The pressure sensing device according to claim 5, wherein the pressure sensor comprises strain sensing resistors, and every four of the strain sensing resistors are electrically connected to form a bridge circuit.

8. The pressure sensing device according to claim 7, wherein the rigid structure has a strain amplification zone, and the four strain sensing resistors in the bridge circuit form two sets of bridge arms opposite to each other; wherein two strain sensing resistors of one set of the bridge arms are arranged corresponding to the strain amplification zone, and two strain sensing resistors of the other set of the opposite bridge arms are arranged to offset the strain amplification zone.

9. The pressure sensing device according to claim 5, wherein the rigid structure and the second substrate are connected through a third adhesive layer.

10. The pressure sensing device according to claim 5, wherein the touch sensor comprises an ultrasonic sensor disposed on the second substrate; or the touch sensor comprises an infrared sensor disposed on the second substrate.

11. The pressure sensing device according to claim 1, wherein the pressure sensor is provided on a surface of the rigid structure, and the pressure sensor is at least one of a microelectromechanical pressure sensor, a capacitance pressure sensor, and an inductive pressure sensor.

12. A pressure sensing method, using the pressure sensing device according to claim 1, the pressure sensing method comprises:
pressing the rigid structure against a measured object;
detecting, by the touch sensor, whether the measured object is touched by an external object; setting the touch processing circuit in a sleep mode when no touch event is detected; and setting the touch processing circuit in a normal mode when a touch event is detected, and detecting a position being touched on the measured object; and
detecting, by the pressure sensor, a deformation of the measured object and obtaining a pressure of the measured object at the touched position.

13. An electronic terminal, comprising:
a measured object; and
the pressure sensing device of claim 1, wherein the rigid structure is pressed against the measured object.

14. The electronic terminal according to claim 13, wherein the measured object is a panel or a frame.

15. The electronic terminal according to claim 13, further comprising a controller configured for outputting a predetermined instruction to control a corresponding actuator according to the touched position obtained by the touch processing circuit and the pressure obtained by the pressure processing circuit.
